(19) United States
(12) Patent Application Publication
(10) Pub. No.: US 2008/0285476 A1
(43) Pub. Date: Nov. 20, 2008

(54) Method and System for Implementing a Forward Error Correction (FEC) Code for IP Networks for Recovering Packets Lost in Transit

(76) Inventor: Yasantha Nirmal Rajakarunanayake, San Ramon, CA (US)

Correspondence Address: MCANDREWS HELD & MALLOY, LTD, 500 WEST MADISON STREET, SUITE 3400, CHICAGO, IL, 60661, US

(21) Appl. No.: 11/868,198

(22) Filed: Oct. 5, 2007

Related U.S. Application Data
(60) Provisional application No. 60/938,672, filed on May 17, 2007.

(51) Int. Cl. H04J 1/16

(52) U.S. Cl. 370/252

(57) ABSTRACT

Certain aspects of a method and system for implementing a forward error correction (FEC) code for Internet Protocol (IP) networks for recovering data packets lost in transit may be disclosed. At least one forward error correction (FEC) packet comprising a first checksum of at least one selected subset of a plurality of data packets may be received by the client. A second checksum of the selected subset of the plurality of data packets excluding one or more lost data packets may be calculated. One or more lost data packets may be recovered based on comparing the first checksum with the calculated second checksum.

### CROSS-REFERENCE TO RELATED APPLICATIONS/INCORPORATION BY REFERENCE

This application makes reference to, claims priority to, and claims benefit of U.S. Provisional Application Ser. No. 60/938,672 (Attorney Docket No. 18623US01) filed May 17, 2007.

The above stated application is hereby incorporated herein by reference in its entirety.

### FIELD OF THE INVENTION

Certain embodiments of the invention relate to error correction codes. More specifically, certain embodiments of the invention relate to a method and system for implementing a forward error correction (FEC) code for Internet Protocol (IP) networks for recovering data packets lost in transit.

### BACKGROUND OF THE INVENTION

In an ideal situation, a transmitter may transmit information over a channel or medium and the transmitted information may be received without alteration and processed by a receiver. However, a transmission medium or channel may be constantly subjected to impairments such as noise and interference. Consequently, when a transmitter transmits information, a receiver may not receive the information in an identical manner in which it was transmitted. This may be due to impairments in a channel that may typically introduce errors in the transmitted information. A transmitter may code the data in such a manner that error introduced during transmission may be detected and/or corrected during reception.

Cyclic redundancy is one method, which may be utilized to code information for transmission so that at least some errors may be detected. However, CRC techniques are error detection algorithms, and are not able to recover lost packets at runtime. A cyclic redundancy check (CRC) may be computed for a group or block of bits referred to as frames. The computed CRC may then be appended to each frame for which a CRC is computed and the frame with the CRC may be transmitted. The appended CRC may be referred to as a frame check sequence (FCS). On the receive side, the frame check sequence may be extracted from the received information and a CRC may be computed for the received information. This calculated CRC of the received frame may then be compared with the frame check sequence and if there is a mismatch, then the received frame may be in error.

In telecommunication, forward error correction (FEC) is a system of error control for data transmission, whereby the sender adds redundant data to its messages, which allows the receiver to detect and correct errors without the need to ask the sender for additional data. The advantage of forward error correction is that retransmission of data can often be avoided, at the cost of higher bandwidth requirements on average, and is therefore applied in situations where retransmissions are relatively costly or impossible.

Today's Internet Protocol Television (IPTV) applications require movement of large data files and content that may include gigabytes of data across IP networks. These IP networks may include carrier access networks such as digital subscriber line (DSL) and/or cable networks, the public Internet or local wired and wireless LANs in customer premises. The IP networks may be capable to transport data packets, but by nature are best effort networks. In other words, if unexpected network conditions such as congestion is encountered, data packets may be dropped based on certain policies. The use of transport control protocol (TCP), an upper layer protocol above IP, may enable requesting retransmission of the lost packets from the origin, and therefore guaranteeing reliability at the expense of possible latency. The TCP/IP may be useful for non-time critical data, for example, unicast data between a server and a client. However, in many cases such as broadcast video, the same content may reach thousands of customers, and multicast IP network delivery may be the best available choice and in such cases, TCP/IP may be unsuitable.

The real-time transport protocol (RTP) may be enabled to provide end-to-end delivery services for data with real-time characteristics such as interactive audio and video applications. Applications typically run RTP above the user datagram protocol (UDP) to make use of its multiplexing and checksum services. The RTP protocol may support data transfer to multiple destinations using multicast distribution if provided by the underlying network.

The use of protocols based on UDP may be capable of multicast operation, but may be unable to request retransmissions. In such cases, a forward error correction code (FEC) may be utilized to recover lost packets in transit over UDP. The Reed-Solomon error correction is an error-correcting code that works by oversampling a polynomial constructed from the data. The polynomial may be evaluated at several points, and these values are sent or recorded. By sampling the polynomial more often than is necessary, the polynomial may be over-determined. As long as many of the points are received correctly, the receiver can recover the original polynomial even in the presence of a few bad points. The Reed-Solomon error correction may require multiplicative operation and dedicated hardware coprocessors, as multiplication and division are expensive for general purpose CPUs in terms of clock cycles.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for implementing a forward error correction (FEC) code for Internet Protocol (IP) networks for recovering data packets lost in transit, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary IPTV communication system, in accordance with an embodiment of the invention.

FIG. 2A is a block diagram of an exemplary IPTV communication system illustrating receipt of FEC packets, in accordance with an embodiment of the invention.

FIG. 2B is a diagram illustrating exemplary packet structure of a RTP FEC packet that may be utilized in connection with an embodiment of the invention.

FIG. 3 is a diagram illustrating exemplary recovery of a lost data packet based on a FEC checksum, in accordance with an embodiment of the invention.

FIG. 4 is a diagram illustrating exemplary recovery of lost data packets based on a FEC checksum, in accordance with an embodiment of the invention.

FIG. 5 is a diagram illustrating exemplary selection of a subset of data packets included in FEC checksum calculation, in accordance with an embodiment of the invention.

FIG. 6 is a diagram illustrating exemplary recovery of lost data packets, in accordance with an embodiment of the invention.

### DETAILED DESCRIPTION OF THE INVENTION

Certain embodiments of the invention may be found in a method and system for implementing a forward error correction (FEC) code for Internet Protocol (IP) networks for recovering data packets lost in transit. At least one forward error correction (FEC) packet comprising a first checksum of at least one selected subset of a plurality of data packets may be received by the client. A second checksum of the selected subset of the plurality of data packets excluding a single lost data packet may be calculated. The lost data packet may be recovered based on comparing the first checksum with the calculated second checksum. The method may be applied iteratively in order to recover a plurality of lost data packets. The method of recovery of lost data packets may be based on the mathematical properties of the XOR operation, for example. Notwithstanding, any logical and/or arithmetic operation comprising error recovery properties may be utilized.

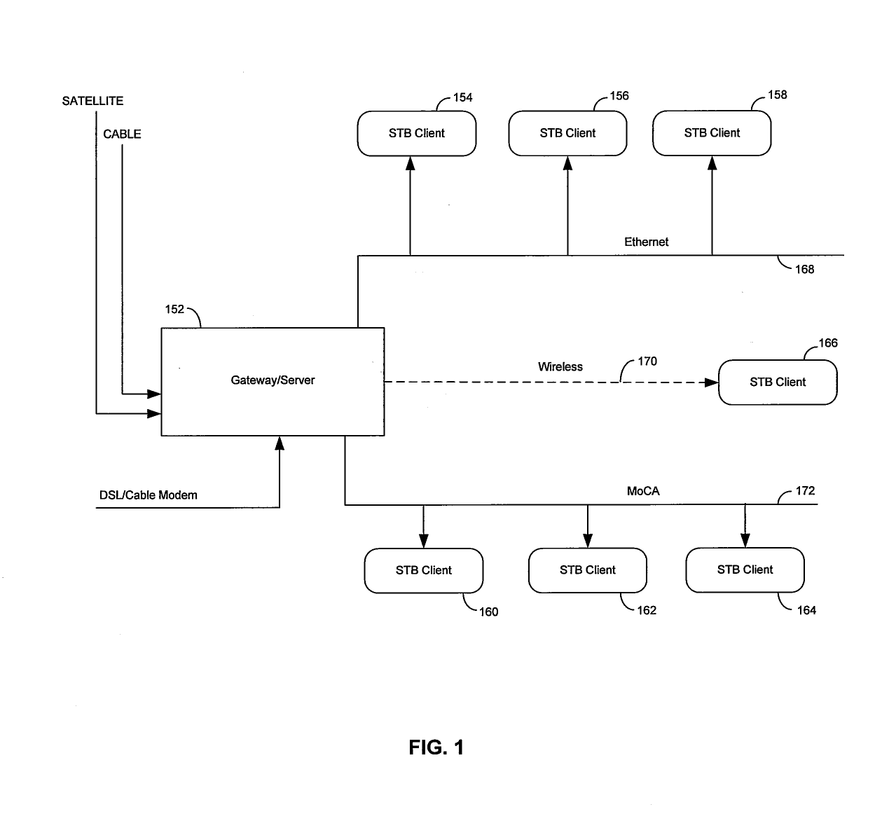

FIG. 1 is a block diagram of an exemplary IPTV communication system, in accordance with an embodiment of the invention. Referring to FIG. 1, there is shown a IP gateway and/or server 152 and a plurality of IP set-top box (STB) clients 154, 156, 158, 160, 162, 164 and 166. The plurality of IP STB clients 154, 156 and 158 may be coupled to the IP gateway and/or server 152 via a wired network, for example, an Ethernet network 168. The IP STB client 166 may be coupled to the IP gateway and/or server 152 via a wireless network 170. The plurality of IP STB clients 160, 162 and 164 may be coupled to the IP gateway and/or server 152 via a wired network, for example, a media over coaxial cable (MoCA) network 172. Notwithstanding, the invention may not be so limited and the plurality of IP STB clients 154, 156, 158, 160, 162, 164 and 166 may be coupled to the IP gateway and/or server 152 via other wired and/or wireless networks. The exemplary IPTV communication system may be embodied in, for example, a home LAN or a corporate LAN with a network bandwidth and capacity that may be higher than the required bandwidth for playing smooth audio or video applications.

The IP gateway and/or server 152 may comprise suitable logic, circuitry and/or code that may be enabled to transmit and/or receive audio, video and/or networking data packets via satellite, cable and/or a DSL/cable modem, for example. The IP gateway and/or server 152 may be a digital media server (DMS), for example. The IP gateway and/or server 152 may be enabled to communicate the received audio, video and/or networking data packets to one or more IP STB clients. The IP gateway and/or server 152 may be enabled to broadcast audio, video and/or networking data packets to thousands of clients via multicast IP network delivery using real-time transport protocol (RTP) over user datagram protocol (UDP). The RTP protocol may support data transfer to multiple destinations using multicast distribution.

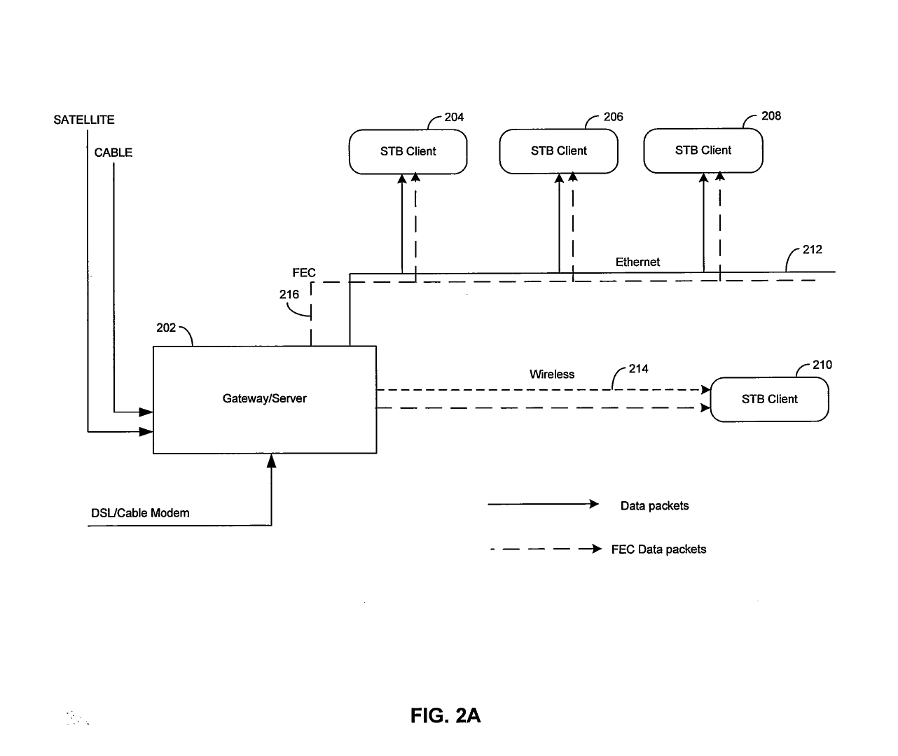

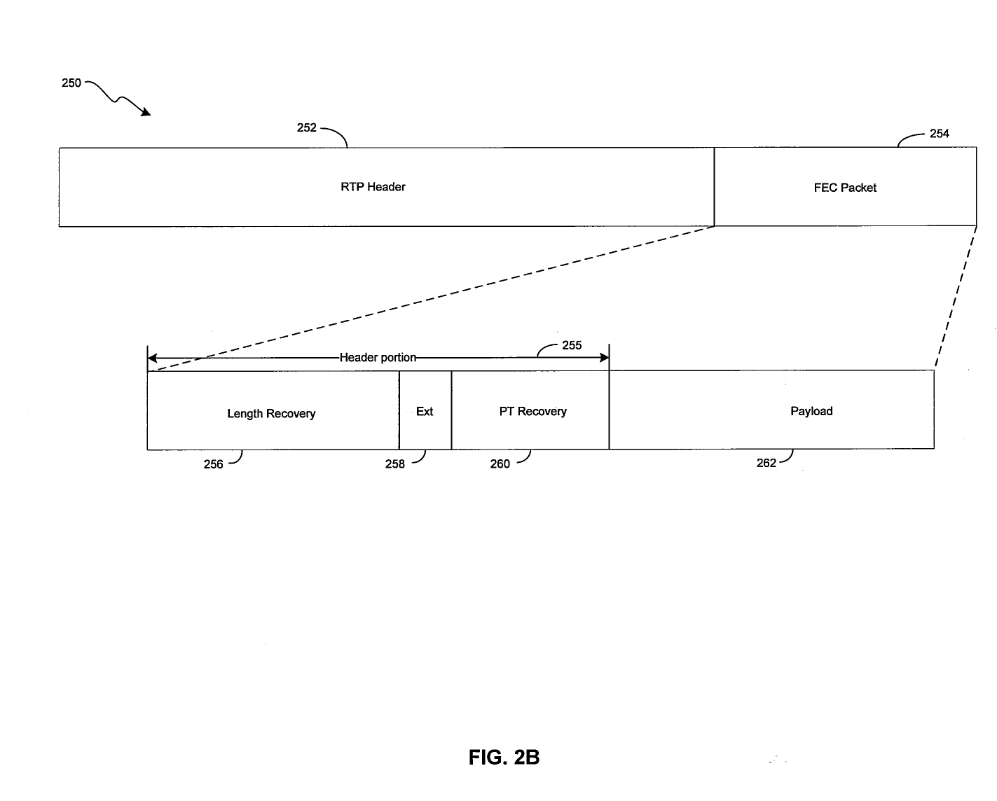

FIG. 2A is a block diagram of an exemplary IPTV communication system illustrating receipt of FEC packets, in accordance with an embodiment of the invention. Referring to FIG. 2A, there is shown a IP gateway and/or server 202 and a plurality of IP STB clients 204, 206, 208 and 210. The plurality of IP STB clients 204, 206 and 208 may be coupled to the IP gateway and/or server 202 via a wired network, for example, an Ethernet network 212. The IP STB client 210 may be coupled to the IP gateway and/or server 202 via a wireless network 214. Notwithstanding, the invention may not be so limited and the plurality of IP STB clients 204, 206, 208 and 210 may be coupled to the IP gateway and/or server 202 via other wired and/or wireless networks.

The IP gateway and/or server 202 may be enabled to communicate audio, video and/or networking data packets to one or more IP STB clients. The IP gateway and/or server 152 may also be enabled to transmit one or more forward error correction code (FEC) packets 216 periodically after a particular number of transmitted data packets. Each of the plurality of IP STB clients 204, 206, 208 and 210 may be enabled to parallelly receive the transmitted FEC packets 216 from the IP gateway and/or server 202 via a separate sideband.

FIG. 2B is a diagram illustrating exemplary packet structure of a RTP FEC packet that may be utilized in connection with an embodiment of the invention. Referring to FIG. 2B, there is shown a RTP FEC packet 250. The RTP FEC packet 250 may comprise a RTP header portion 252 and a FEC packet portion 254. The FEC packet portion 254 may comprise a FEC header portion 255 and a FEC payload portion 262. The FEC header portion 255 may comprise a length recovery field 256, an extension field 258 and a packet type recovery field 260 among other fields.

The RTP header portion 252 may comprise a plurality of fields, for example, a version field that identifies the version of the RTP, a padding field that indicates whether the packet comprises one or more additional zeros that are not part of the payload, a sequence number field that may comprise a sequence number that is one higher than the sequence number of the previously transmitted data packet, a synchronization source (SSRC) field and a contributing source (CSRC) field.

The length recovery field 256 may be utilized to determine the length of any recovered lost data packets. The value of the length recovery field 256 may be computed by XORing the lengths (in bytes) of the data payloads associated with the FEC packet portion 254. For example, if the lengths of two data packets are 3 (0b011) and 5 (0b101) bytes, respectively, the length recovery field 256 may be encoded as 0b011 XOR 0b101=0b110.

The extension field 258 may indicate a header extension. When the extension field 258 is set to 1, this may indicate that an additional 32 bits of header may follow, for example. The PT recovery field 260 may be set to a function f( ), for example, XOR function applied to the payload types of the data packets associated with the FEC packet portion 254.

The FEC payload portion 262 may comprise a function f( ) operator, for example, an exclusive OR (XOR) operator applied to the payloads of the data packets associated with the FEC packet portion 254. In accordance with an embodiment of the invention, if the payloads are not of equal length, they may be padded with zeroes to be as long as the longest payload before computing the function f( ).

In operation, if one of the IP STB clients, for example, IP STB client 204 has received a plurality of data packets and FEC packets, but one or more of the plurality of data packets with sequence number Xi is lost in transit, the lost data packet with sequence number Xi may be recovered. The IP STB client 204 may determine whether it has received sufficient data packets in order to recover the lost data packet with sequence number Xi. For example, the IP STB client 204 may receive an FEC packet portion 254 associated with the lost data packet with sequence number Xi, and a plurality of data packets associated with the FEC packet portion 254.

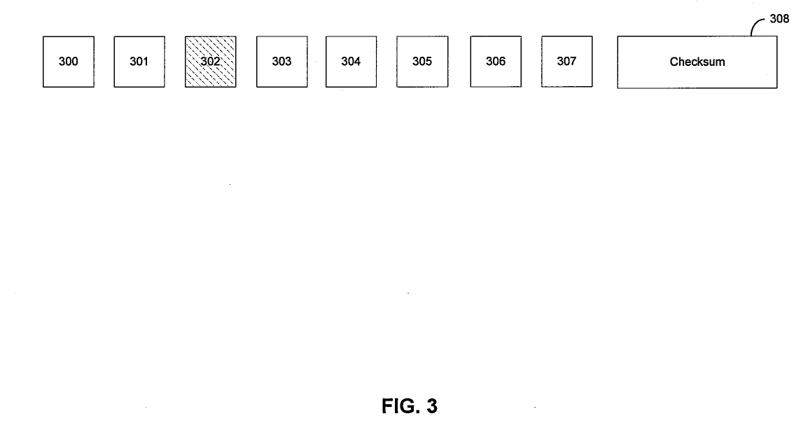

FIG. 3 is a diagram illustrating exemplary recovery of a lost data packet based on a FEC checksum, in accordance with an embodiment of the invention. Referring to FIG. 3, there is shown a plurality of data packets 300, 301, 303, 304, 305, 306 and 307 received by a receiver, for example, IP STB client 204, a lost data packet 302 and a FEC checksum packet 308.

The FEC checksum packet 308 may be transmitted by the IP gateway and/or server 202 and may comprise a FEC checksum value. The FEC checksum value may be calculated by applying a linear function, for example, XORing the payloads of each of the plurality of data packets transmitted by the IP gateway and/or server 202, for example, 300, 301, 302, 303, 304, 305, 306 and 307. A second checksum value may be calculated by XORing the payloads of each of the plurality of data packets received by the IP STB client 204, for example, 300, 301, 303, 304, 305, 306 and 307. The lost data packet 302 may be recovered based on comparing the FEC checksum value with the calculated second checksum value. For example, the lost data packet 302 may be recovered by XORing the FEC checksum value with the calculated second checksum value.

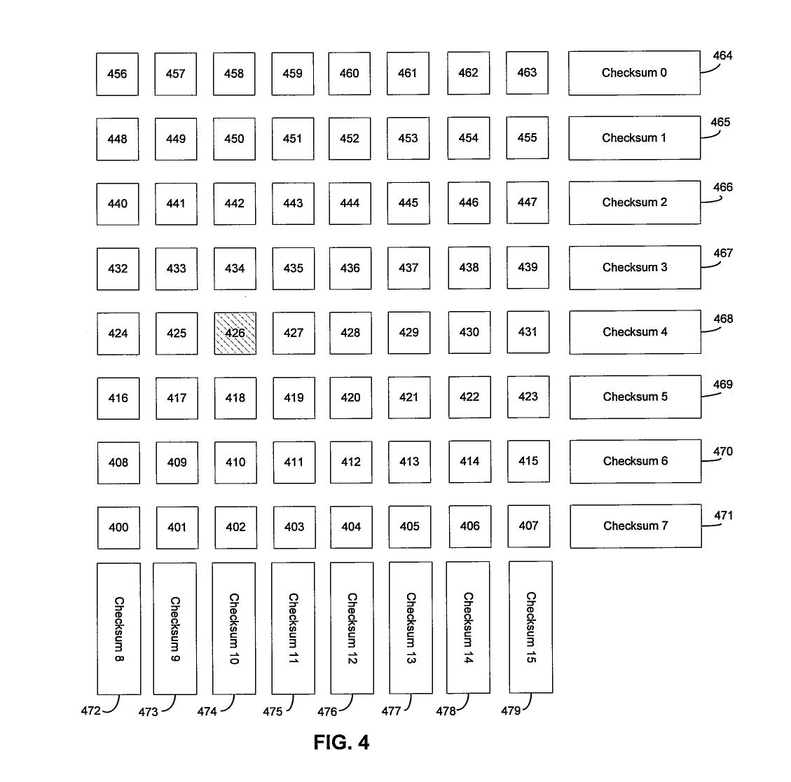

FIG. 4 is a diagram illustrating exemplary recovery of lost data packets based on a FEC checksum, in accordance with an embodiment of the invention. Referring to FIG. 4, there is shown a plurality of data packets in a matrix format 400, 401, 402, 403, 404, 405, 406, 407, 408, 409, 410, 411, 412, 413, 414, 415, 416, 417, 418, 419, 420, 421, 422, 423, 424, 425, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462 and 463 received by a receiver, for example, IP STB client 204, a lost data packet 426 and a plurality of FEC checksum packets, checksum 0 464, checksum 1 465, checksum 2 466, checksum 3 467, checksum 4 468, checksum 5 469, checksum 6 470, checksum 7 471, checksum 8 472, checksum 9 473, checksum 10 474, checksum 11 475, checksum 12 476, checksum 13 477, checksum 14 478 and checksum 15 479.

Each of the plurality of FEC checksum packets may be transmitted by the IP gateway and/or server 202 and may comprise a FEC checksum value. As shown in FIG. 4, each of the FEC checksum values may be calculated by applying a linear function, for example, XORing each of the plurality of data packets in a particular row or column. The value of checksum 0 464 may be calculated by XORing the payloads of each of the plurality of data packets transmitted by the IP gateway and/or server 202 in the first row, for example, 456, 457, 458, 459, 460, 461, 462 and 463. The value of checksum 1 465 may be calculated by XORing the payloads of each of the plurality of data packets transmitted by the IP gateway and/or server 202 in the second row, for example, 448, 449, 450, 451, 452, 453, 454 and 455. The value of checksum 2 466 may be calculated by XORing the payloads of each of the plurality of data packets transmitted by the IP gateway and/or server 202 in the third row, for example, 440, 441, 442, 443, 444, 445, 446 and 447. The value of checksum 3 467 may be calculated by XORing the payloads of each of the plurality of data packets transmitted by the IP gateway and/or server 202 in the fourth row, for example, 432, 433, 434, 435, 436, 437, 438 and 439. The value of checksum 4 468 may be calculated by XORing the payloads of each of the plurality of data packets transmitted by the IP gateway and/or server 202 in the fifth row, for example, 424, 425, 426, 427, 428, 429, 430 and 431. The value of checksum 5 469 may be calculated by XORing the payloads of each of the plurality of data packets transmitted by the IP gateway and/or server 202 in the sixth row, for example, 416, 417, 418, 419, 420, 421, 422 and 423. The value of checksum 6 470 may be calculated by XORing the payloads of each of the plurality of data packets transmitted by the IP gateway and/or server 202 in the seventh row, for example, 408, 409, 410, 411, 412, 413, 414 and 415. The value of checksum 7 471 may be calculated by XORing the payloads of each of the plurality of data packets transmitted by the IP gateway and/or server 202 in the eighth row, for example, 400, 401, 402, 403, 404, 405, 406 and 407.

The value of checksum 8 472 may be calculated by XORing the payloads of each of the plurality of data packets transmitted by the IP gateway and/or server 202 in the first column, for example, 456, 448, 440, 432, 424, 416, 408 and 400. The value of checksum 9 473 may be calculated by XORing the payloads of each of the plurality of data packets transmitted by the IP gateway and/or server 202 in the second column, for example, 457, 449, 441, 433, 425, 417, 409 and 401. The value of checksum 10 474 may be calculated by XORing the payloads of each of the plurality of data packets transmitted by the IP gateway and/or server 202 in the third column, for example, 458, 450, 442, 434, 426, 418, 410 and 402. The value of checksum 11 475 may be calculated by XORing the payloads of each of the plurality of data packets transmitted by the IP gateway and/or server 202 in the fourth column, for example, 459, 451, 443, 435, 427, 419, 411 and 403. The value of checksum 12 476 may be calculated by XORing the payloads of each of the plurality of data packets transmitted by the IP gateway and/or server 202 in the fifth column, for example, 460, 452, 444, 436, 428, 420, 412 and 404. The value of checksum 13 477 may be calculated by XORing the payloads of each of the plurality of data packets transmitted by the IP gateway and/or server 202 in the sixth column, for example, 461, 453, 445, 437, 429, 421, 413 and 405. The value of checksum 14 478 may be calculated by XORing the payloads of each of the plurality of data packets transmitted by the IP gateway and/or server 202 in the seventh column, for example, 462, 454, 446, 438, 430, 422, 414 and 406. The value of checksum 15 479 may be calculated by XORing the payloads of each of the plurality of data packets transmitted by the IP gateway and/or server 202 in the eighth column, for example, 463, 455, 447, 439,431, 423, 415 and 407.

The lost data packet 426 may be recovered based on comparing the checksum 4 468 value with a calculated second checksum value. The second checksum value may be calculated by XORing the payloads of each of the plurality of data packets received by the IP STB client 204 in the fifth row, for example, 424, 425, 427, 428, 429, 430 and 431. The lost data packet 426 may be recovered by XORing the checksum 4 468 value with the calculated second checksum value.

In another embodiment of the invention, the lost data packet 426 may be recovered based on comparing the checksum 10 474 value with a calculated third checksum value. The third checksum value may be calculated by XORing the payloads of each of the plurality of data packets received by the IP STB client 204 in the third column, for example, 458, 450, 442, 434, 418, 410 and 402. The lost data packet 426 may be recovered by XORing the checksum 10 474 value with the calculated third checksum value.

If two or more data packets are lost within a single column, the corresponding row checksums may be utilized to recover the lost data packets. Similarly, if two or more data packets are lost within a single row, the corresponding column checksums may be utilized to recover the lost data packets. For example, if data packets 426 and 442 are lost during transit, they may be recovered based on comparing the checksum 2 466 value with a calculated fourth checksum value and comparing the checksum 4 468 value with the calculated second checksum value respectively. The fourth checksum value may be calculated by XORing the payloads of each of the plurality of data packets received by the IP STB client 204 in the third row, for example, 440, 441, 443, 444, 445, 446 and 447. The lost data packet 426 may be recovered by XORing the checksum 4 468 value with the calculated second checksum value and the lost data packet 442 may be recovered by XORing the checksum 2 466 value with the calculated fourth checksum value.

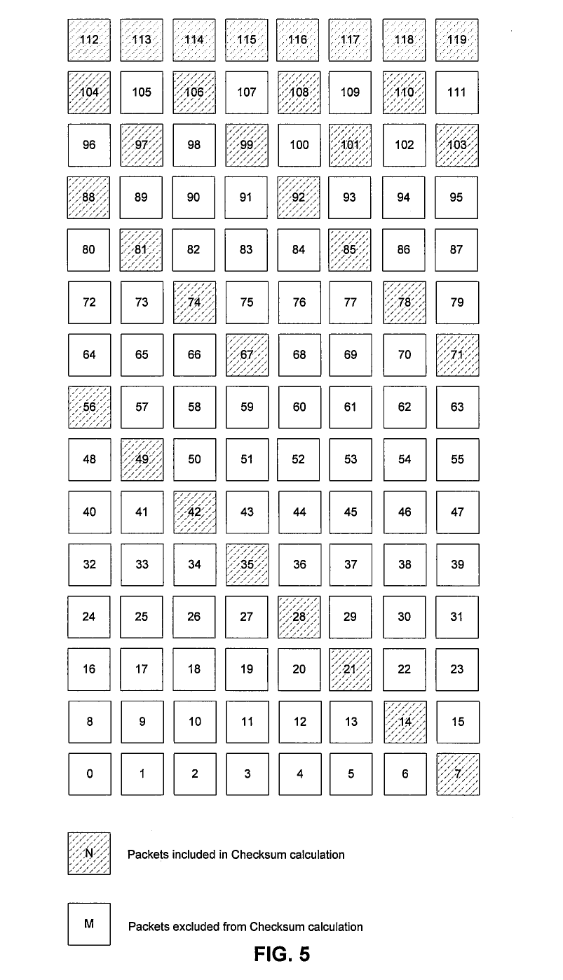

In accordance with an embodiment of the invention, an advanced method for error correction may comprise a FEC algorithm based on a binary search technique as described in FIG. 5. The binary search technique may provide better error correction properties compared to other techniques by reducing the extra bandwidth usage. The FEC algorithm may be applied progressively in order to recover lost data packets that have occurred in a certain past time window automatically. The error correcting capacity of the FEC packets may not be limited to a single block of data. The FEC packets that are received may be able to correct lost data packets from a past time period, for example, lost data packets as old as several thousand data packets as long as the data packets are buffered, and most of the lost data packets are recoverable, or the average error rate is less than the extra bandwidth used.

FIG. 5 is a diagram illustrating exemplary selection of a subset of data packets included in FEC checksum calculation, in accordance with an embodiment of the invention. Referring to FIG. 5, there is shown a plurality of data packets, for example, 120 data packets, 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118 and 119 received by a receiver, for example, the IP STB client 204.

In accordance with an embodiment of the invention, a selected subset of the plurality of data packets may be included in the FEC checksum calculation. For example, the plurality of data packets 7, 14, 21, 28, 35, 42, 49, 56, 67, 71, 74, 78, 81, 85, 88, 92, 97, 99, 101, 103, 104, 106, 108, 110, 112, 113, 114, 115, 116, 117, 118 and 119 may be included in the FEC checksum calculation. The plurality of data packets with depth D equal to, for example, 120 data packets may be arranged in a row interval of interleave I equal to 8 data packets, for example. The plurality of data packets may be encapsulated in RTP protocol, which may provide a 16-bit sequence number for each packet.

The plurality of data packets encapsulated in RTP may be received from a network driver and the socket buffers associated with each data packet may be queued in an input queue at the IP gateway and/or server 202. In accordance with an embodiment of the invention, a 256 packet holding queue may be utilized before selecting a subset of the data packets for FEC checksum calculation. Each new arriving packet may be added to the tail of the queue. If the queue length reaches a particular threshold value, for example, a depth of 256 data packets, one or more received data packets may be dequeued and transmitted to a decoder or upper layer software, for example. The FEC packets may be queued in a separate FEC queue, for example, with a depth of about 32 FEC packets in the FEC queue.

The receiver, for example, each IP STB client may be enabled to determine the particular lost data packets that may be recovered based on the sequence number field in the RTP header of the received FEC packet. In accordance with an embodiment of the invention, an FEC sequence number (x) may be enabled to recover the lost data packets among the plurality of data packets transmitted with sequence numbers equal to x−N+F(i), where x is the sequence number of the FEC packet, N is the number of recently transmitted data packets and F(i) is the selected subset of data packets included in FEC checksum calculation. For example, if sequence number of the FEC packet, x=121, the number of recently transmitted data packets, N=120 and F(i)={7, 14, 21, 28, 35, 42, 49, 56, 67, 71, 74, 78, 81, 85, 88, 92, 97, 99, 101, 103, 104, 106, 108, 110, 112, 113, 114, 115, 116, 117, 118, 119}, where the values of I may span over the numbers in the above set of 32 values, the receiver, for example, IP STB client 204 may be enabled to recover one of the lost data packets among the plurality of data packets transmitted with sequence numbers in the set {8, 15, 22, 29, 36, 43, 50, 57, 68, 72, 75, 79, 82, 86, 89, 93, 98, 100, 102, 104, 106, 108, 109, 111, 113, 114, 115, 116, 117, 118, 119, 120}.

When the plurality of data packets are received by a receiver, for example, the IP STB client 204, a data packet that is lost during transmission may be detected based on the sequence number of the received data packets. For example, if the IP STB client 204 receives data packets with sequence numbers, 1001, 1002, 1004 and 1005, the IP STB client 204 may detect that the data packet with sequence number 1003 is lost in transit. The plurality of received data packets may be stored in a holding packet buffer, where the lost data packet may be empty.

When a FEC packet is received by a receiver, for example, the IP STB client 204, the number of lost data packets may be calculated. If the IP STB client 204 determines that only one data packet is lost, then a checksum may be computed excluding the lost data packet from the holding packet buffer. The lost data packet may be recovered by applying a linear function, for example, XORing the calculated checksum with the FEC checksum. One or more fields of the FEC packet may be replaced with the recovered data packet, and may be inserted into the holding packet buffer with the correct sequence number in the receiver, for example, the IP STB client 204. This process of correction may consume the FEC packet and generate a recovered data packet. As each lost data packet is recovered, prior FEC packets may be reused to recover more lost data packets.

In accordance with an embodiment of the invention, the oldest lost data packets may be recovered first as these data packets may be pushed to the upper layer first. The later arriving data packets in the queue may be subsequently recovered by later arriving FEC packets. Each FEC packet may be enabled to recover one or more lost data packets within a selected subset of data packets. The burstiness of the data packets from a FEC block may be reduced by dequeuing a corresponding data packet from a queue as each data packet is queued.

In accordance with an embodiment of the invention, at least one FEC packet may be received periodically after receiving a particular number of the plurality of data packets. For example, at least one FEC packet may be received periodically after receiving 2^{N} data packets, where N is equal to a number of lost data packets and 2^{N} may be referred to as the interleave I. If one or more FEC packets are lost, the receiver, for example, the IP STB client 204 may wait for more FEC packets to arrive. The average lost data packet rate of the network, for example, Ethernet 212 may be below (1/I). If the number of transmitted FEC packets are above the rate 1/I, then more lost data packets may be recovered by the FEC packets. If duplicate FEC packets are received by the receiver, for example, the IP STB client 204, they may be discarded.

If one or more of the plurality of received data packets are variable length data packets, the FEC checksum may be calculated by padding each of the plurality of received variable length data packets with one or more zeros up to a maximum transmission unit (MTU) size, for example. A second checksum may be calculated by excluding a sequence number field of each of the plurality of received variable length data packets. The FEC checksum may be calculated prior to UDP processing of the plurality of data packets by a TCP/IP stack as the UDP headers in the FEC packet may be scrambled during checksum calculation and may not be passable to an upper layer stack.

In accordance with an embodiment of the invention, a binary search technique may be utilized to select a subset of data packets to be included in the FEC checksum calculation. A subset of data packets to be included in the FEC checksum calculation may be selected from a number (D) of data packets required to recover N lost data packets may be equal to (2^{N+1}−1)*(2^{N}), where interleave I may be equal to 2^{N}. For example, if the number of lost data packets, N=3, the interleave I may be equal to 8 and the depth D may be equal to 15×8=120 data packets. A FEC packet may be transmitted after every 8 data packets and any given FEC packet may be enabled to recover at least one lost data packet within the last 120 received data packets.

In accordance with another embodiment of the invention, the number of lost data packets that may be recovered may be increased by increasing a holding buffer size of the FEC packet. The method may be suited for CPU oriented error recovery as the mathematical operations such as XOR operations are linear and may be completed in a single clock cycle of the CPU between two operands. The method may be scalable to multi-processing or hardware acceleration and may be advantageous compared to other FEC techniques, which may require multiplicative operation. For example, Reed-Solomon FEC codes may require dedicated hardware coprocessors for implementation, as multiplication and division may be expensive for general purpose CPUs in terms of clock cycles. The method may be tunable based on a rate of occurrence of lost data packets and reduce the bandwidth consumed by the FEC packets.

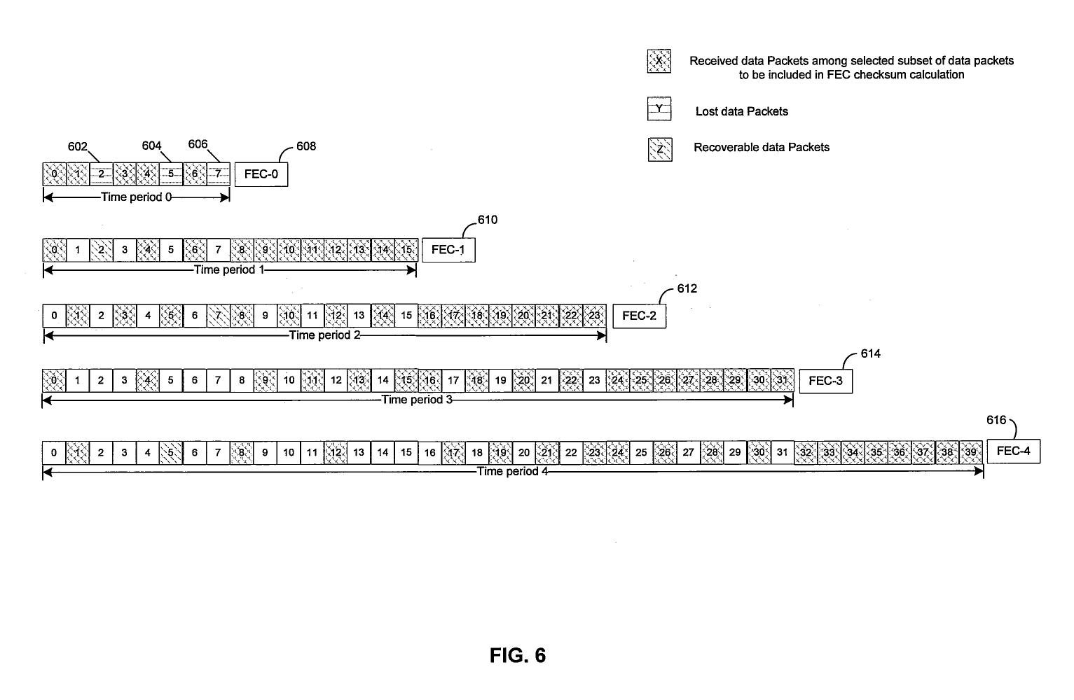

FIG. 6 is a diagram illustrating exemplary recovery of lost data packets, in accordance with an embodiment of the invention. Referring to FIG. 6, there is shown a plurality of data packets, for example, data packets with sequence numbers 0, 1, 2, 3, 4, 5, 6 and 7 transmitted by a IP gateway and/or server 202 in time period 0. The receiver, for example, an IP STB client 204 may be enabled to receive one or more of the transmitted data packets, for example, data packets with sequence numbers 0, 1, 3, 4 and 6 in time period 0. The plurality of data packets 602, 604 and 606 with sequence numbers 2, 5 and 7 respectively may be lost in transit, for example. The receiver, for example, the IP STB client 204 may be enabled to receive a FEC-0 packet 608 comprising a FEC-0 checksum value.

The FEC-0 packet 608 may be received after 8 data packets, for example. The FEC-0 checksum value may be calculated based on by applying a linear function, for example, XORing a selected subset of the plurality of data packets selected from a number (D) of data packets required to recover N lost data packets that may be equal to (2^{N+1}−1)*(2^{N}), where interleave I may be equal to 2^{N}. For example, since the number of lost data packets, N=3, the interleave I may be equal to 8 and the depth D may be equal to 15×8=120 data packets. The FEC-0 checksum value may be calculated based on XORing the payloads of each of the data packets with sequence numbers 0, 1, 2, 3, 4, 5, 6 and 7 of the plurality of data packets. A second checksum 0 value may be calculated based on XORing the payloads of each of the received data packets with sequence numbers 0, 1, 3, 4 and 6 of the plurality of data packets. The FEC-0 packet 608 may not be able to recover the 3 lost data packets yet and the receiver, for example, the IP STB client 204 may wait for subsequent FEC packets.

During time period 1, a plurality of data packets, for example, data packets with sequence numbers 0, 1, 2, 3, 4, 5, 6, 7, 8, 9, 10, 11, 12, 13, 14 and 15 may be transmitted by the IP gateway and/or server 202. The receiver, for example, the IP STB client 204 may be enabled to receive one or more of the transmitted data packets to be included in the FEC checksum calculation, for example, data packets with sequence numbers 0, 4, 6, 8, 9, 10, 11, 12, 13, 14 and 15 in time period 1. The data packet with sequence number 2 may be lost in transit, for example, but may be recoverable. The receiver, for example, the IP STB client 204 may be enabled to receive a FEC-1 packet 610 comprising a FEC-1 checksum value.

The FEC-1 packet 610 may be received after 8 data packets, for example. The FEC-1 checksum value may be calculated based on XORing a selected subset of the plurality of data packets selected from the last transmitted 120 data packets. The FEC-1 checksum value may be calculated based on XORing the payloads of each of the data packets with sequence numbers 0, 2, 4, 6, 8, 9, 10, 11, 12, 13, 14 and 15 of the plurality of data packets. A second checksum 1 value may be calculated based on XORing the payloads of each of the received data packets with sequence numbers 0, 4, 6, 8, 9, 10, 11, 12, 13, 14 and 15 of the plurality of data packets. The FEC-1 packet 610 may be enabled to recover the lost data packet 602 with sequence number 2 by XORing the FEC-1 checksum value with the calculated second checksum 1 value at the receiver, for example, at the IP STB client 204.

During time period 2, a plurality of data packets, for example, data packets with sequence numbers 0, 1, 2, 3, 4, 5, 6, 7, 8, 9, 10, 11, 12, 13, 14, 15, 16, 17, 18, 19, 20, 21, 22 and 23 may be transmitted by the IP gateway and/or server 202. The receiver, for example, the IP STB client 204 may be enabled to receive one or more of the transmitted data packets to be included in the FEC checksum calculation, for example, data packets with sequence numbers 1, 3, 5, 8, 10, 12, 14, 16, 17, 18, 19, 20, 21, 22 and 23 in time period 2. The data packet with sequence number 7 may be lost in transit, for example. The receiver, for example, the IP STB client 204 may be enabled to receive a FEC-2 packet 612 comprising a FEC-2 checksum value.

The FEC-2 packet 612 may be received after 8 data packets, for example. The FEC-2 checksum value may be calculated based on XORing a selected subset of the plurality of data packets selected from the last transmitted 120 data packets. The FEC-2 checksum value may be calculated based on XORing the payloads of each of the data packets with sequence numbers 1, 3, 5, 7, 8, 10, 12, 14, 16, 17, 18, 19, 20, 21, 22 and 23 of the plurality of data packets. A second checksum 2 value may be calculated based on XORing the payloads of each of the received data packets with sequence numbers 1, 3, 5, 8, 10, 12, 14, 16, 17, 18, 19, 20, 21, 22 and 23 of the plurality of data packets. The FEC-2 packet 612 may be enabled to recover the lost data packet 606 with sequence number 7 by XORing the FEC-2 checksum value with the calculated second checksum 2 value at the receiver, for example, at the IP STB client 204. After recovering the lost data packets 602 and 606, a third checksum 0 value may be calculated based on XORing the payloads of each of the received and recovered data packets with sequence numbers 0, 1, 2, 3, 4, 6 and 7 of the plurality of data packets. The FEC-0 packet 608 may be enabled to recover the lost data packet 604 with sequence number 5 by XORing the FEC-0 checksum value with the calculated third checksum 0 value at the receiver, for example, at the IP STB client 204. The lost data packet 604 with sequence number 5 may also be recovered by XORing the FEC-4 checksum value with a calculated second checksum 4 value at the receiver, for example, at the IP STB client 204.

During time period 3, a plurality of data packets, for example, data packets with sequence numbers 0, 1, 2, 3,4, 5, 6, 7, 8, 9, 10, 11, 12, 13, 14, 15, 16, 17, 18, 19, 20, 21, 22, 23, 24, 25, 26, 27, 28, 29, 30 and 31 may be transmitted by the IP gateway and/or server 202. The receiver, for example, the IP STB client 204 may be enabled to receive one or more of the transmitted data packets to be included in the FEC checksum calculation, for example, data packets with sequence numbers 0, 4, 9, 11, 13, 15, 14, 16, 18, 20, 22, 24, 25, 26, 27, 28, 29, 30 and 31 in time period 3. The receiver, for example, the IP STB client 204 may be enabled to receive a FEC-3 packet 614 comprising a FEC-3 checksum value. The FEC-3 packet 614 may be received after 8 data packets, for example. The FEC-3 checksum value may be calculated based on XORing a selected subset of the plurality of data packets selected from the last transmitted 120 data packets. The FEC-3 checksum value may be calculated based on XORing the payloads of each of the data packets with sequence numbers 0, 4, 9, 11, 13, 15, 14, 16, 18, 20, 22, 24, 25, 26, 27, 28, 29, 30 and 31 of the plurality of data packets.

During time period 4, a plurality of data packets, for example, data packets with sequence numbers 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38 and 39 may be transmitted by the IP gateway and/or server 202. The receiver, for example, the IP STB client 204 may be enabled to receive one or more of the transmitted data packets to be included in the FEC checksum calculation, for example, data packets with sequence numbers 1, 8, 12, 17, 19, 21, 23, 24, 26, 28, 30, 32, 33, 34, 35, 36, 37, 38 and 39 in time period 4. The data packet with sequence numbers 5 may be lost in transit, for example. The receiver, for example, the IP STB client 204 may be enabled to receive a FEC-4 packet 616 comprising a FEC-4 checksum value.

The FEC-4 packet 616 may be received after 8 data packets, for example. The FEC-4 checksum value may be calculated based on XORing a selected subset of the plurality of data packets selected from the last transmitted 120 data packets. The FEC-4 checksum value may be calculated based on XORing the payloads of each of the data packets with sequence numbers 1, 5, 8, 12, 17, 19, 21, 23, 24, 26, 28, 30, 32, 33, 34, 35, 36, 37, 38 and 39 of the plurality of data packets. A second checksum 4 value may be calculated based on XORing the payloads of each of the received data packets with sequence numbers 1, 8, 12, 17, 19, 21, 23, 24, 26, 28, 30, 32, 33, 34, 35, 36, 37, 38 and 39 of the plurality of data packets. The FEC-4 packet 616 may be enabled to recover the lost data packet 604 with sequence number 5 by XORing the FEC-4 checksum value with the calculated second checksum 4 value at the receiver, for example, at the IP STB client 204.

In accordance with an embodiment of the invention, the FEC packets may be transmitted parallelly via a sideband channel to each of the receivers, for example, IP STB clients. A particular receiver may choose not to tune into the FEC sideband channel to conserve bandwidth and may be backwards compatible with end stations which do not have capability to handle FEC packets. In accordance with another embodiment of the invention, the method may be utilized to recover lost data packets transmitted via any protocol that tracks packets with a sequence number. For example, the method may be utilized to recover lost data packets transmitted via UDP protocol.

In accordance with an embodiment of the invention, a method and system for implementing a forward error correction (FEC) code for Internet Protocol (IP) networks for recovering data packets lost in transit may be disclosed. A plurality of data packets may be received from a server, for example, the IP gateway and/or server 202 via a unicast network and/or a multicast network connection via one or more of: a DSL network, a cable modem network, Ethernet network 168 and a media over coaxial cable (MoCA) network 172. The plurality of data packets may be received from a server, for example, the IP gateway and/or server 202 via one or more wired network connections, for example, an Ethernet network 212 or via a wireless network connection, for example, wireless network 214. Notwithstanding, the invention may not be so limited and the plurality of receivers, for example, IP STB clients may be connected to the IP gateway and/or server 202 via other wired and/or wireless networks.

At least one forward error correction (FEC) packet, for example, FEC-1 packet 610 comprising a first checksum, for example, FEC-1 checksum value of at least one selected subset of a plurality of data packets may be received by the client, for example, the IP STB client 204. The at least one selected subset of the plurality of data packets may be, for example, data packets with sequence numbers 0, 2, 4, 6, 8, 9, 10, 11, 12, 13, 14 and 15 of the plurality of data packets. A second checksum 1 value of the selected subset of the plurality of data packets excluding one or more lost data packets, for example, lost data packet 602 with sequence number 2 may be calculated based on XORing the payloads of each of the received data packets with sequence numbers 0, 4, 6, 8, 9, 10, 11, 12, 13, 14 and 15 of the plurality of data packets. The lost data packet 602 with sequence number 2 may be recovered based on comparing the FEC-1 checksum value with the calculated second checksum 1 value. For example, the lost data packet 602 with sequence number 2 may be recovered based on XORing the FEC-1 checksum value with the calculated second checksum 1 value at the receiver, for example, at the IP STB client 204. Notwithstanding, other linear mathematical operations, for example, addition without carry of the bits of the FEC packet may be utilized to recover one or more lost data packets, for example, the lost data packet 602 with sequence number 2.

At least one FEC packet may be received after receiving a particular number of the plurality of data packets. Notwithstanding, the FEC packet may be received before receiving a particular number of the plurality of data packets. The particular number of the plurality of data packets may be equal to 2^{N}, where N is equal to a number of the lost data packets. For example, the FEC-1 packet 610 may be received periodically after 8 data packets, if 3 data packets are lost in transit. The periodicity of transmitting the FEC packets may be adjusted based on a rate of occurrence of the lost data packets.

The FEC-1 checksum value may be calculated based on XORing a selected subset of the plurality of data packets selected from a number (D) of data packets required to recover N lost data packets that may be at least equal to (2^{N+1}−1)*(2^{N}), where interleave I may be equal to 2^{N}. For example, since the number of lost data packets, N=3, the interleave I may be equal to 8 and the depth D may be equal to 15×8=120 data packets. In accordance with another embodiment of the invention, the depth (D1) of data packets required to recover N lost data packets may be at least equal to (2^{M+1}−1)*(2^{N}), where M may depend on a number of FEC packets to be received by a client, for example, IP STB client 204 before recovering lost data packets. The value of M may be chosen so that the depth D1 is a multiple of depth D. The value of M may be equal to N, if the rate of occurrence of lost data packets is low. The client, for example, IP STB client 204 may utilize a progressive error correction technique in order to recover the lost data packets. The plurality of lost data packets may be recovered based on progressively comparing the FEC checksum with subsequently calculated second checksums. The rate of recovery of lost data packets may be proportional to the rate of receipt of FEC packets by the client, for example, IP STB client 204.

If one or more of the plurality of received data packets are variable length data packets, the FEC checksum may be calculated by padding each of the plurality of received variable length data packets with one or more zeros up to a maximum transmission unit (MTU) size, for example. A second checksum may be calculated by excluding a sequence number field of each of the plurality of received variable length data packets.

Another embodiment of the invention may provide a machine-readable storage, having stored thereon, a computer program having at least one code section executable by a machine, thereby causing the machine to perform the steps as described above for implementing a forward error correction (FEC) code for Internet Protocol (IP) networks for recovering data packets lost in transit.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for recovering data packets, the method comprising:
receiving at least one forward error correction (FEC) packet comprising a first checksum of at least one selected subset of a plurality of data packets;
calculating a second checksum of said at least one selected subset of said plurality of data packets excluding one or more lost data packets; and
recovering said one or more lost data packets based on comparison between said first checksum with said calculated second checksum.

2. The method according to claim 1, comprising XORing said first checksum with said calculated second checksum to recover said one or more lost data packets.

3. The method according to claim 1, comprising receiving said at least one FEC packet after receiving a particular number of said plurality of data packets.

4. The method according to claim 3, wherein said particular number of said plurality of data packets is equal to 2^{N}, where N is equal to a number of said one or more lost data packets.

5. The method according to claim 3, comprising modifying said particular number of said plurality of data packets based on a rate of occurrence of said one or more lost data packets.

6. The method according to claim 1, wherein said at least one selected subset of said plurality of data packets is at least equal to (2^{N+1}−1)*(2^{N}), where N is equal to a number of said one or more lost data packets.

7. The method according to claim 1, comprising calculating said first checksum by padding each of said plurality of data packets with one or more zeros when said plurality of data packets comprise variable length data packets.

8. The method according to claim 7, comprising calculating said second checksum by excluding a sequence number field of each of said plurality of data packets if said plurality of data packets comprise variable length data packets.

9. The method according to claim 1, wherein a rate of recovering said one or more lost data packets is proportional to a rate of receiving said at least one FEC packet.

10. The method according to claim 1, comprising recovering said one or more lost data packets based on progressively comparing said first checksum with subsequently calculated second checksums.

11. The method according to claim 1, comprising receiving said plurality of data packets from a server via one or more of: a wired network connection and a wireless network connection.

12. The method according to claim 1, comprising receiving said plurality of data packets over a multicast network via one or more of: a DSL network, a cable modem network, Ethernet network and a media over coaxial cable (MoCA) network.

13. A system for recovering data packets, the system comprising:
one or more circuits that enable receipt of at least one forward error correction (FEC) packet comprising a first checksum of at least one selected subset of a plurality of data packets;
said one or more circuits enable calculation of a second checksum of said at least one selected subset of said plurality of data packets excluding one or more lost data packets; and
said one or more circuits enable recovery of said one or more lost data packets based on comparison between said first checksum with said calculated second checksum.

14. The system according to claim 13, wherein said one or more circuits enable XORing of said first checksum with said calculated second checksum to recover said one or more lost data packets.

15. The system according to claim 13, wherein said one or more circuits enable receipt of said at least one FEC packet after receiving a particular number of said plurality of data packets.

16. The system according to claim 15, wherein said particular number of said plurality of data packets is equal to 2^{N}, where N is equal to a number of said one or more lost data packets.

17. The system according to claim 15, wherein said one or more circuits enable modification of said particular number of said plurality of data packets based on a rate of occurrence of said one or more lost data packets.

18. The system according to claim 13, wherein said at least one selected subset of said plurality of data packets is equal to (2^{N+1}−1)*(2^{N}), where N is equal to a number of said one or more lost data packets.

19. The system according to claim 13, wherein said one or more circuits enable calculation of said first checksum by padding each of said plurality of data packets with one or more zeros, when said plurality of data packets are variable length data packets.

20. The system according to claim 19, wherein said one or more circuits enable calculation of said second checksum by excluding a sequence number field of each of said plurality of data packets, when said plurality of data packets are said variable length data packets.

21. The system according to claim 13, wherein a rate of recovering said one or more lost data packets is proportional to a rate of receiving said at least one FEC packet.

22. The system according to claim 13, wherein said one or more circuits enable recovery of said one or more lost data packets based on progressive comparison of said first checksum with subsequently calculated second checksums.

23. The system according to claim 13, wherein said one or more circuits enable receipt of said plurality of data packets from a server via one or more of: a wired network connection and a wireless network connection.

24. The system according to claim 13, wherein said one or more circuits enable receipt of said plurality of data packets over a multicast network via one or more of: a DSL network, a cable modem network, Ethernet network and a media over coaxial cable (MoCA) network.
